(19) United States
(12) Patent Application Publication
(10) Pub. No.: US 2012/0091671 A1
(43) Pub. Date: Apr. 19, 2012

(54) SLED

(76) Inventor: Alex Soloviev, Richmond Hill (CA)

(21) Appl. No.: 12/905,608

(22) Filed: Oct. 15, 2010

(51) Int. Cl. B62B 13/16

(52) U.S. Cl. 280/20

(57) ABSTRACT

The invention relates to a sled or snow chair that includes a foldable frame pivotally supported on a pair of runners and a passenger support unit movably supported on the foldable frame. The foldable frame has a deployed position and a folded position. When in its deployed position, the passenger support unit is secured to the foldable frame and maintains the foldable frame in its deployed position. The sled or snow chair can be maintained in the folded position for easy storage and transportation.

### FIELD OF INVENTION

The invention relates generally to the field of recreational and transportation equipment. In particular, the invention relates to a light weight transportation device, such as a sled or snow chair, for transporting a passenger across snowy terrain.

### BACKGROUND OF INVENTION

During winter months in more northern climates, ground tends to be covered with snow. Generally it is more challenging to pull or maneuver strollers supported on wheels over snow covered ground. Nevertheless, it is still desirable to take a young child out for a walk despite the cold weather. Baby sleds may be used. However, typical baby sleds are simple “pull” devices. When pulling a sled, a user may have difficulty seeing the passenger sitting in the sled behind the user. Similar difficulties may be encountered when transporting a person in wheelchair across snowy terrain. It would be desirable to have a sled that a user can “push”, and therefore allow good visibility of the passenger and control of the sled when the sled is being pushed forward for transporting the passenger over showy or icy terrain. It is an object of the present invention to mitigate or obviate at least one of the above mentioned disadvantages.

### SUMMARY OF INVENTION

The invention relates to a sled or a chair that includes a foldable frame pivotally supported on a pair of runners and a passenger support unit, such as a seat, movably supported on the foldable frame. The foldable frame has a deployed position and a folded position. When in the deployed position, the passenger support unit is secured to the foldable frame and maintains the foldable frame in its deployed position. To allow the frame to move to its folded position, the passenger support unit is moved away from the secured position so that the frame can be folded for storage or transportation.

In one embodiment, the foldable frame has two side frames. Each side frame has an inclined front leg and a rear leg pivotally joined to the front leg. The front leg has a lower half and an upper half pivotally joined to each other by way of a pivot connection. The upper end of the rear leg is pivotally joined to the front leg. The rear leg extends downwardly and rearwardly from the front leg and is supported on the runner. Pivoting of the upper and lower halves about the pivot connection toward each other brings the foldable frame into its folded position and pivoting of the upper and lower halves away from each other moves the foldable frame into its deployed position.

The foldable frame may include a handle. In one embodiment, the handle is telescopically connected to the frame or has a telescopic construction such that its length can be adjusted to any one of pre-selected heights to accommodate users of different heights. Each runner has an elongated ground support portion for supporting the weight of the sled and its passenger, such as a young child. The runner has an arcuately shaped front segment extending forwardly and upwardly from the ground support portion and terminating at a front tip. The front segment engages and cooperates with the handle when the foldable frame is in its folded position to discourage the folded frame from unfolding.

In a first aspect of the invention, there is a sled that includes a foldable frame pivotally supported on a pair of runners, a passenger support unit movably supported on the foldable frame, and cooperating engagement arrangements formed on the foldable frame and the passenger support unit. The foldable frame has a folded position for storage and transportation and a deployed position. The cooperating engagement arrangements releasably secure the passenger support unit to the foldable frame when the foldable frame is in the deployed position and maintain the foldable frame in the deployed position.

In a feature of this aspect of the invention, the handle is in pressure contact with at least one of the runners, when the foldable frame is in the folded position, to maintain the foldable frame in the folded position.

In yet another feature of this aspect of the invention, the cooperating engagement arrangements include a clamp secured to one of the passenger support unit and the foldable frame and a mating engagement portion integrally formed on the other of the passenger support unit and the foldable frame, the clamp releasably engaging the mating engagement portion when the foldable frame is in the deployed position.

In another aspect of the invention, there is a foldable chair for transporting a passenger that includes a pair of runners, a frame including a pair of front legs and a pair of rear legs, each of the rear legs being pivotally joined to one of the front legs, the front legs and the rear legs being supported by the runners and at least one of the front and rear legs being pivotally joined to one of the runners, each of the front legs having an upper half and a lower half pivotally connected to the upper half, and a front crossbar joining the pair of front legs in a spaced relationship, a seat pivotally joined to the rear legs, the seat being movable between a lowered position and a lifted position, the seat being releasably secured to the frame and supported by the front crossbar when in the lowered position for supporting the passenger and detached from the front crossbar when in the lifted position.

In a feature of this aspect of the invention, the frame further includes a top rail disposed between and connected to the front legs at a height above the front crossbar and the set includes a seat base frame pivotally joined to the rear legs and a seat fabric removably attached to and suspended between the seat base frame and the top rail to form the seat base and the seat back.

In another feature of this aspect of the invention, the chair further includes cooperating engagement arrangements formed on the seat and the frame, the cooperating engagement arrangements releasably securing the seat to the frame when the seat is in the lowered position.

In yet another feature of this aspect of the invention, the frame further includes a handle, the handle having an engagement member for engaging at least one of the runners when the frame is in a folded position to maintain the frame in the folded position.

In yet another feature of this aspect of the invention, the frame further includes a handle, the handle being in pressure contact with at least one of the runners when the frame is in the folded position.

In other aspects the invention provides various combinations and subsets of the aspects described above.

### BRIEF DESCRIPTION OF DRAWINGS

For the purposes of description, but not of limitation, the foregoing and other aspects of the invention are explained in greater detail with reference to the accompanying drawings, in which:

FIG. 1 is a perspective view showing a sled in its deployed position;

FIG. 2A is a perspective view showing the sled of FIG. 1, with seat fabric removed to more clearly show the construction of the sled;

FIG. 2B is a side view of the sled of FIG. 2A;

FIG. 2C is a perspective view showing the sled of FIG. 2A in a partially folded position;

FIG. 2D is a perspective view showing the sled of FIG. 2A in its folded position;

FIG. 3A shows in detail the connection region joining the lower and upper halves of the front leg of the sled of FIG. 1;

FIG. 3B is a front view of the connection region shown in FIG. 3A;

FIG. 4A shows in detail the connection region joining the rear leg and the front leg;

FIG. 4B shows in detail an alternative construction of the rear leg joined to the front leg;

FIGS. 5A and 5B show in detail in a perspective view and a sectional view, respectively, the cooperating locking members for securing the seat to the foldable frame to maintain the sled in its folded position; and

FIG. 6 shows in a side view a different construction of a runner of the sled.

### DETAILED DESCRIPTION OF EMBODIMENTS

The description which follows and the embodiments described therein are provided by way of illustration of an example, or examples, of particular embodiments of the principles of the present invention. These examples are provided for the purposes of explanation, and not limitation, of those principles and of the invention. In the description which follows, like parts are marked throughout the specification and the drawings with the same respective reference numerals.

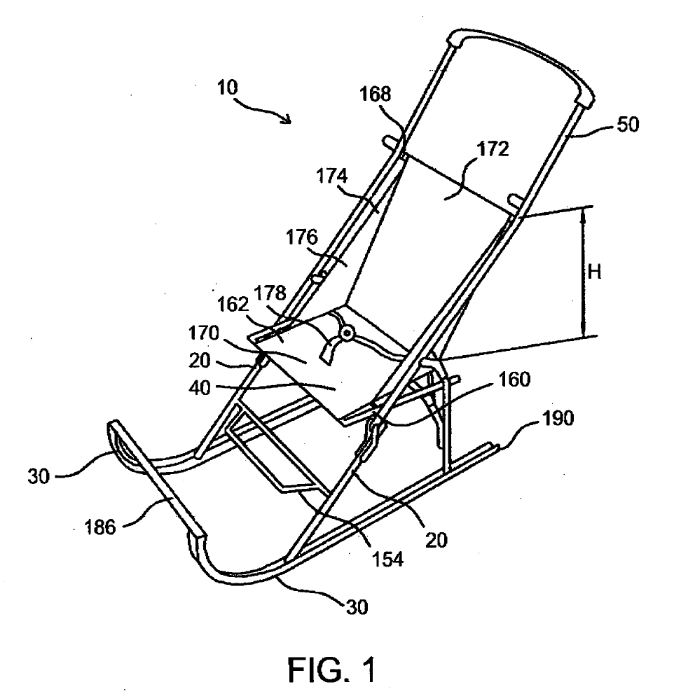

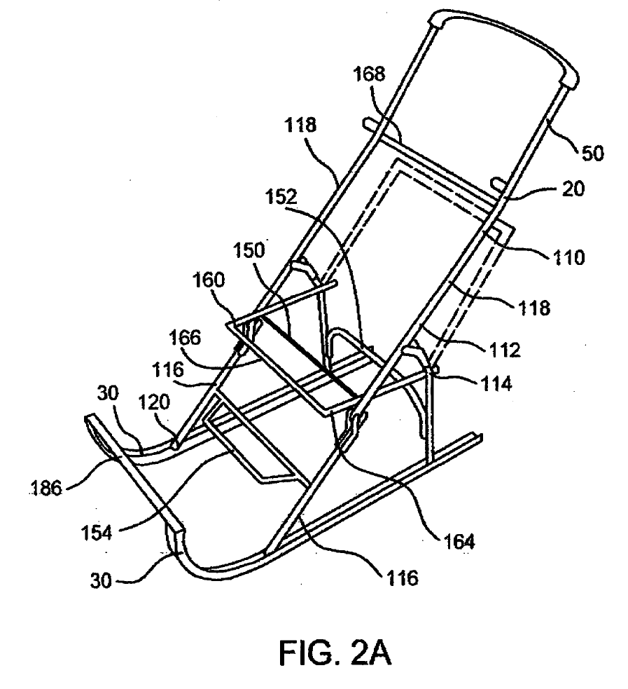

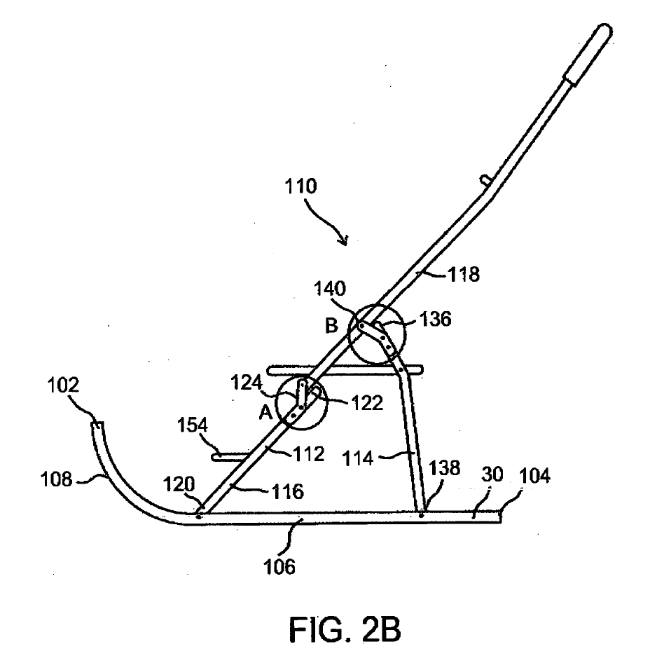

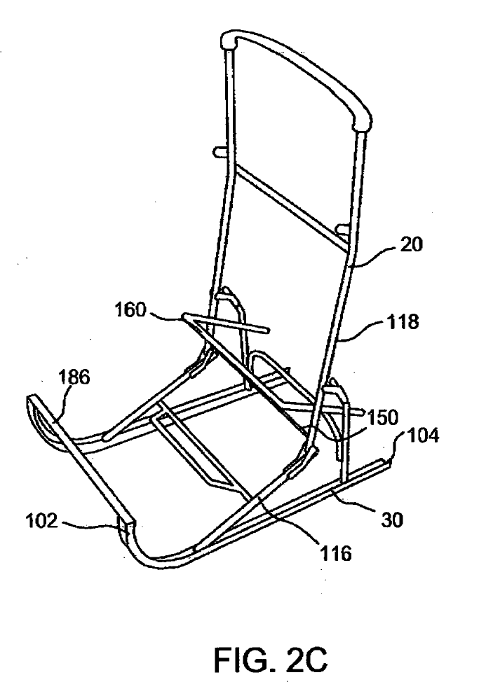

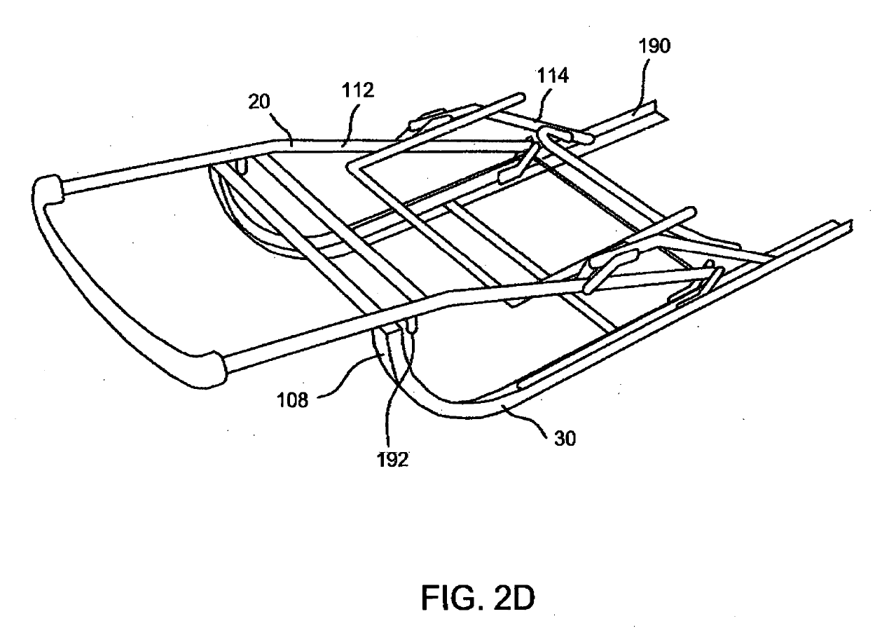

FIG. 1 shows a sled 10 according to an embodiment of the present invention. The sled 10 includes a foldable frame 20 pivotally supported on a pair of runners 30 and a passenger support unit 40 movably supported on the foldable frame. The foldable frame 20 includes a handle 50. The handle may have a telescopic construction or may be telescopically connected to the foldable frame, to accommodate users of different heights, as will be described later. The foldable frame 20 has a deployed position as depicted in FIG. 1 (and FIG. 2A) and a folded position as depicted in FIG. 2D. When in its deployed position, the passenger support unit 40 is secured to the foldable frame 20 and maintains the foldable frame 20 in its deployed position. When the foldable frame is in the folded position, the handle may be optionally configured to cooperate with the runner to encourage the foldable frame to rest in the folded position, as will be described in detail later.

Referring to FIG. 2B (and FIGS. 1 and 2A through 2D), between its front end 102 and rear end 104, each runner 30 has an intermediate elongated ground support portion 106 for supporting the weight of the sled 10 and a passenger. An arcuately shaped front segment 108 of the runner extends forwardly and upwardly from the ground support portion 106. The front segment 108 has a shape that curves upwardly, thus allowing the sled to be moved over uneven surfaces more easily.

The foldable frame 20 has two side frames 110 (see FIGS. 2A and 2B). Each side frame 110 has a front leg 112, which extends downwardly and forwardly in the deployed position. A rear leg 114 is pivotally joined to the front leg. Rear leg 114 extends downwardly and rearwardly towards and is supported by runner 30. Preferably, both front legs are pivotally joined to the runners, for example, with durable metal bolts or rivets, so are the rear legs. The frame may be made from tubular aluminum members. Other lightweight, durable materials also can be used.

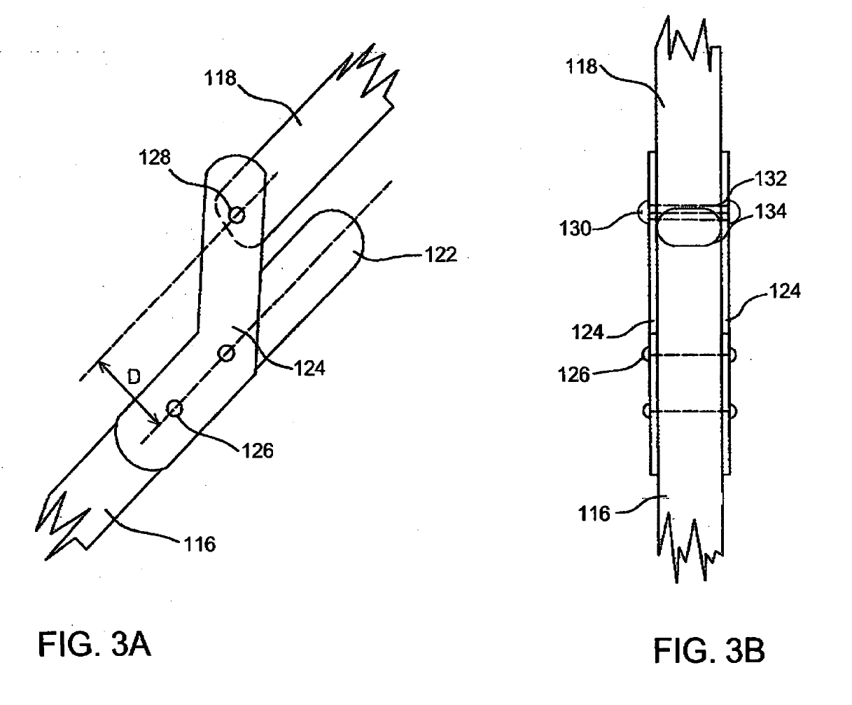

Each front leg 112 has a lower half 116 and an upper half 118. The lower half 116 has a first end 120 and a second end 122. The lower half is pivotally connected to the runner 30 adjacent its first end 120. The lower and upper halves of the front leg are pivotally joined together, as shown in FIG. 2B and more clearly shown in FIGS. 3A and 3B. A first link 124, is fixedly secured to the lower half 116 adjacent the second end 122 by a pair of first rivets 126 and pivotally connected to the upper half 118 at a first pivot connection 128, formed, for example, with a first pivot pin 130 and first throughholes 132 in the first link 124 and the upper half 118 of the front leg.

The first link 124 may consist of one piece or a pair. Preferably, the link has two opposing halves for attaching to opposite sides of the lower half of the front leg, as shown in FIG. 3B. Conveniently, both opposing halves have essentially the same construction, to reduce manufacturing costs. The first throughhole 132 is placed in the first link 124 at a location such that the first pivot connection 128 formed with the first throughhole 132 and the first pivot pin 130 is at a distance D from the axis of the lower half of the front leg. The distance D is larger than the diameter of the upper half of the front leg. The distance D is also larger than the distance between the first throughhole 132 and the terminal tip 134 of the upper half 118, thus allowing unhindered pivoting of the upper and lower halves of the front leg about the first pivot connection 128 when moving the foldable frame between its deployed and folded positions. As will be understood by those skilled in the art, the first link 124 may be oriented as shown in FIG. 3A, thus allowing the upper half and the lower half of the front leg to pivot towards each other in one direction. The first link 124 may also be oriented with the first pivot connection 128 placed below the axis of the lower half of the front leg, so that the upper half 118 and the lower half 116 may pivot towards each other in another direction.

Each side frame 110 also includes a rear leg 114. The rear leg 114 is pivotally joined to the upper half 118 of the front leg 112 or any other suitable section of the front leg, adjacent its upper end 136. The rear leg 114 extends downwardly and rearwardly from the front leg 112 and towards the runner. Each rear leg is movable relative to and supported by a runner. The rear leg may be connected to the runner by way of a pivot connection, for example, adjacent its lower end 138. However, the rear legs do not have to be pivotally connected to the runners. For example, rear legs may be slidably supported by the runners and restrained to slide within a pre-determined range along the runners.

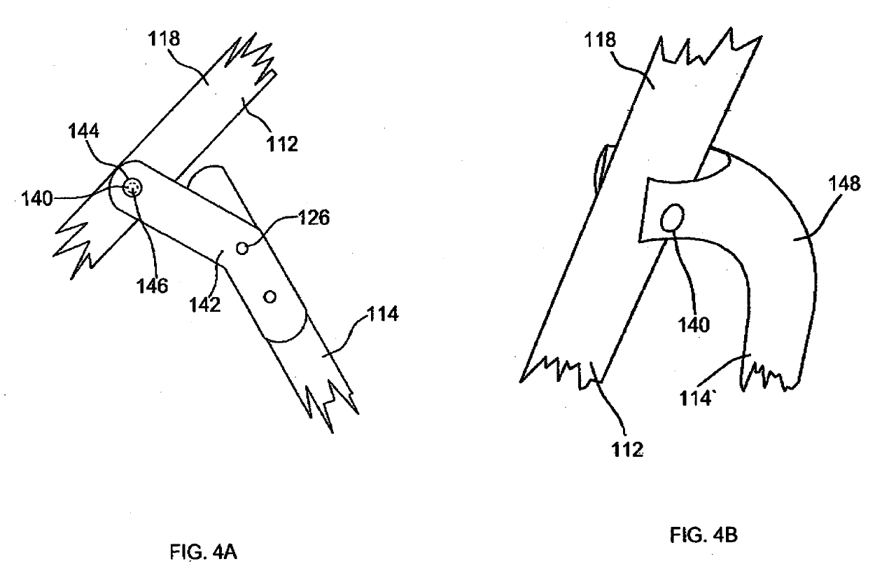

The rear leg is pivotally connected to the front leg at a second pivot connection 140 adjacent the upper end 136 of the rear leg. A second link 142 is fixedly secured to the rear leg 114, for example, by another pair of rivets 126, adjacent the upper end of the rear leg. The second pivot connection 140 may be formed, for example, with a second pivot pin 144 and second throughholes 146 in the second link 142 and front leg 112. FIG. 4 illustrates in detail the connection region (region B in FIG. 2A) according to one construction. The second link may be similarly constructed as the first link. The placement of the second throughholes 146 is such that the rear leg can pivot unhindered about the second pivot connection when moving the foldable frame between its deployed and folded positions.

Alternatively, the rear leg may be directly connected to the front leg. FIG. 4B illustrates such an alternative construction. As shown in FIG. 4B, the rear leg 114′ has a curved terminal end 148. The curved terminal end 148 spaces the straight portion of the rear leg from the second pivot connection 140, thereby providing the necessary clearance to allow the rear leg to be brought in an essentially side-by-side relationship with the front leg 112 when the frame 20 is folded. Of course, the first pivot connection 128 joining the lower and upper halves of the front leg can also be similarly constructed, in the manner illustrated in FIG. 4B. Instead of joining the lower and upper halves with the first link 124, one of the upper or lower half may have a curved end for joining to the other half and providing the necessary clearance to allow the upper and lower halves pivoting about their pivot connection.

Referring to FIG. 2A, the foldable frame 20 includes at least a lateral spacer to link the pair of side frames 110 together and to maintain the side frames in a laterally spaced relationship. The lateral spacer may be in the form of a front crossbar 150, although also may be in other suitable forms, such as a front panel. The front crossbar 150 may be tubular or solid. Each end of the front crossbar 150 is secured to one of the front legs 112. Optionally, a rear cross bar 152 is provided, each end of which is secured to one of the rear legs 114 to provide increased stability and strength. The rear cross bar may be formed from a tubular blank or a solid bar. A foot rest 154 can also be optionally provided. It can be secured to the front legs 112 or any other suitable part of the foldable frame 20.

The passenger support unit 40 can be in the form of a removable seat, a liftable seat, or any other suitable construction for supporting a passenger. In FIG. 1, a liftable seat 40 is depicted. The liftable seat is pivotally connected to the foldable frame. According to one construction, the liftable seat is formed with a seat base frame 160 and seat fabric 162 attached thereto. The seat base frame 160 may be formed from a U-shaped tubular member that has two legs 164 and a central connection segment 166 (FIG. 2A). The seat fabric 162 is removably attached to the seat base frame 160. Each leg of the U-shaped seat base frame 160 is pivotally coupled to and supported by the side frame 110. A durable bolt may be used for the pivot connection. Pivotable connection of the seat base frame 160 to the foldable frame 20 allows the seat base frame 160 to be movable between a lowered position, resting on and supported by the front crossbar 150, and a lifted position, detached from the front crossbar, allowing the foldable frame to be moved into the folded position. FIG. 2A indicates with dashed lines the seat base frame in a typical lifted position.

Optionally, a top rail 168 joins two side frames 110 together in a spaced relationship. The top rail 168 is positioned above and generally at a height H from the front crossbar 150, or the seat base frame 160. The seat fabric 162 can be suspended between the top rail 168 and the central connection segment 166 of the seat base frame, thereby forming both a seat base 170 and a back 172 for the seat (FIG. 1). The seat fabric can also include sections to form side panels 174, each side panel suspended between a leg of the seat base frame 160 and the foldable frame 20, such as the top rail or a side frame, to form side protection shields 176, for protecting a passenger such as a young child from adverse environment elements, such as wind. For easy removal for cleaning, the seat fabric may be removably attached to the seat base frame and the frame, for example, with buttons, snaps, Velcro™, or the like. A securing member, such as a three-way security belt 178, may be provided for restraining and/or securing the young child to the sled.

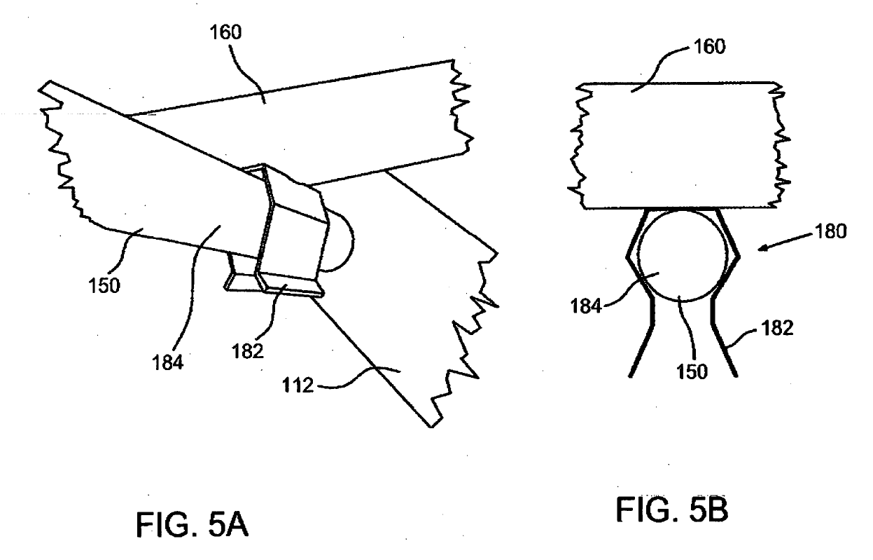

Referring to FIGS. 5A and 5B, engagement arrangements such as cooperating locking members 180 are provided on the seat base frame 160 and the front crossbar 150 to releasably secure the seat base frame to the front crossbar when the seat is in the lowered position. The locking members 180 also allow the seat base frame 160 to be disengaged from the front crossbar 150 when the seat base frame is to be lifted. The locking member can be in the form of a clamp 182 secured to the seat base frame, for example, by welding, for engaging with a mating engagement section 184, which is an integral part of the front crossbar 150 (see FIGS. 5A and 5B). Although it is possible to use only one such clamp to secure the seat base frame 160 to the front crossbar 150, two or more such clamps are preferred for added security and safety. Of course, although the clamps are welded to the seat base frame according to one construction, it is also possible to weld the clamps to the crossbar or front legs for engaging the seat base frame. Alternatively, welding can be replaced with riveting, screws, or any other suitable means. In addition, although clamps are depicted and described here, any other suitable engagement mechanisms, such as hooks, latches, lugs and mating apertures, to name a few, may be used for releasably securing the seat base frame.

When the seat base frame 160 is lowered and secured to the foldable frame 20, the seat base frame 160, the front leg 112 and the rear leg 114 form a triangle on each side of the sled. Thus, the seat base frame 160 maintains the foldable frame 20 in the deployed position and helps maintaining the stability of the foldable frame 20 in its deployed position.

As will be appreciated, when a seat includes both a seat base and a seat back, sled 10 becomes a snow chair, or a foldable chair that can be more easily moved across snow for transporting a passenger in a seated position. Such a foldable chair can be useful, for example, for transporting outdoors a person of impaired mobility, not necessarily a young child, during winter times. As can be seen in FIG. 1 and FIG. 2A, one such foldable chair includes a pair of runners 30 and a frame that includes a pair of front legs 112, and a pair of rear legs 114 pivotally joined to the front leg 112, both pairs of front and rear legs being pivotally joined to and supported by the runners. The liftable seat 40 of the chair, which includes a seat base 170 and a seat back 172, is pivotally joined to the rear legs and supported by the front crossbar 150 when the seat is lowered to its lowered position.

Referring to FIG. 2A and FIG. 2B, each runner 30 has an elongated ground support portion 106. The ground support portion is generally flat and provides weight support when the sled is used on snow covered surface. The ground support portion 106 should be sufficiently wide for a smooth ride on soft snow surfaces. A narrower runner may tend to sink into soft snow more easily, and therefore provide a less enjoyable ride for the passenger.

However, the runner also should not be too wide as to cause undesirable ground traction, rendering the sled difficult to maneuver. Preferably, the width should be between ½″ and 1½″. In general, a width of about 1″ is more preferred. Optionally, a transverse beam 186 is provided to join the front end 102 of the runners 30 and keep the pair of runners 30 in a spaced relationship.

The runners may be formed from metal strips having a generally flat undersurface, L-bars, T-bars, among others. For enhanced strength but without significantly increased weight, each runner 30 may be provided with an upright flange 190 extending upwardly and running lengthwise along the runner 30 (FIG. 1). Conveniently, the runner may be made from an L-bar. One of the legs of the L forms the flange 190. Alternatively, the runner may be formed from a T-bar, thereby placing the upright flange 190 toward the center line of the runner. Other configurations of upright flange may also be possible. Although in FIG. 1, the upright flange 190 is shown to extend the entire length of the runners, the upright flange may also extend a fraction of the length of the runners. Conveniently, the foldable frame 20 may be pivotally connected to the flanges 190. In general, the runner may be made from any suitable materials that can provide a smooth ride over snowy or icy surface, though, preferably the runner should also be light weight and durable and can be made, for example, from aluminum or fiberglass.

When the first pivot connection 128 joining the lower half 116 and upper half 118 of the front leg 112 is moved backwards, the lower half 116 of the front leg 112 is brought toward the runner. The upper end 136 of the rear leg 114 is moved forward and is rested near the front end 102 of the runner 30, thus bringing the frame to the folded position. FIG. 2C illustrates the foldable frame in a partially folded position. FIG. 2D illustrates the foldable frame in an essentially folded position. Of course, the first pivot connection 128 may also be moved forwards to fold the frame, by rearranging the relative position of upper half 118 and lower half 116 shown in FIG. 3A, namely by moving the upper half 118 to the underside of the lower half 116. Optionally, an engagement member 192 is provided on the foldable frame 20 or the handle 50. The engagement member 192 may be made from metal or a more resilient material. When the frame is in the folded position, the engagement 192 is in pressure contact against the runner 30 or the transverse beam 186, thus releasably engages the runner 30 or the transverse beam 186 to retain the foldable frame (and therefore the sled) in the folded position. Of course, the engagement member 192 may also be in the form of clamps, hooks or any other suitable form.

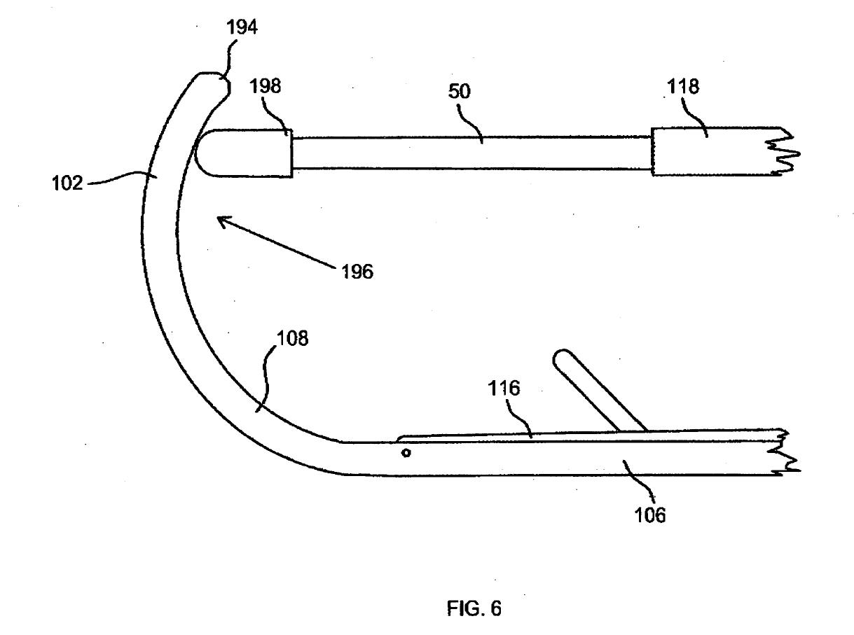

To further improve the ability to retain the foldable frame 20 in its folded position, the runner 30 is shaped to cooperate with handle 50 to retain the foldable frame in the folded position. Referring to FIG. 6, according to an alternative construction, front segment 108 also curves backwards, i.e., toward the middle of the runner, thus forming a generally forwardly curved bow-like shape, such as a C-shape, or any other generally open profile, such as an inclined L or a U-shape turned by about 90 degrees. With a front segment 108 having such a generally forwardly curved shape, the runner tip 194 of the runner overhangs above the ground support portion of the runner and forms a mouth between the overhanging runner tip 194 and the ground support portion 106, and thereby forms a recessed space 196 forward of the mouth longitudinally along the runner 30. A handle 50, having a telescopic construction or telescopically connected to the foldable frame, is provided. Pins and matching holes, or other suitable mechanisms, may be provided for maintaining the handle 50 at any one of pre-selected lengths. Conveniently, one of the pre-selected lengths of the handle is such that, in the folded position, the handle 50 is received in the recessed space 196 defined by the arcuately shaped front segments 108 of the runners. When received in the recessed space, the handle 50 cooperates with the front segments 108 and discourages the folded frame from unfolding. Thus, the handle, and therefore the foldable frame, is discouraged from moving away from the folded position.

Advantageously, a spring or other resilient element may be provided to maintain the handle in pressure contact engagement with the front segment. According to this construction, the engagement member 192 may be in the form of a foam or rubber handgrip 198 wrapped around the handle. The resilient handgrip 198 maintains the handle 50 in pressure contact against the front segment 108 of the runners. Alternatively, the handle is telescopically connected to the frame or has a telescopic construction such that the handle may have one pre-selected length, at which length the handle can move toward and away from the recessed space unhindered. When the frame is folded, a spring element (not shown) disposed inside the tubular frame biases the handle 50 towards the front segment 108 and maintains the handle in pressure contact against the front segment, thus urging the handle to remain in the recessed space 196 and discouraging the handle from moving away from the runner. Thus, even without an engagement member, this arrangement also tends to keep the foldable frame in its folded position when folded.

Various embodiments of the invention have now been described in detail. Those skilled in the art will appreciate that numerous modifications, adaptations and variations may be made to the embodiments without departing from the scope of the invention. Since changes in and or additions to the above-described best mode may be made without departing from the nature, spirit or scope of the invention, the invention is not to be limited to those details but only by the appended claims.

What is claimed is:

1. A sled comprising:
a foldable frame pivotally supported on a pair of runners, the foldable frame having a folded position for storage and transportation and a deployed position,
a passenger support unit movably supported on the foldable frame, and
cooperating engagement arrangements formed on the foldable frame and the passenger support unit, the cooperating engagement arrangements releasably securing the passenger support unit to the foldable frame when the foldable frame is in the deployed position and maintaining the foldable frame in the deployed position.

2. The sled of claim 1, wherein the foldable frame further includes two side frames and a lateral spacer, said lateral spacer linking said side frames and maintaining said side frames in a laterally spaced relationship.

3. The sled of claim 2, wherein each said side frame has a front leg and a rear leg pivotally joined to the front leg, the front legs and the rear legs being supported by the runners and at least one of the front and rear legs being pivotally joined to one of the runners, said front leg having an upper half and a lower half pivotally joined to the upper half.

4. The sled of claim 1, wherein said cooperating engagement arrangements include a clamp secured to one of the passenger support unit and the foldable frame and a mating engagement portion integrally formed on the other of the passenger support unit and the foldable frame, said clamp releasably engaging the mating engagement portion when the foldable frame is in the deployed position.

5. The sled of claim 1, wherein the foldable frame further includes a handle, the handle having an engagement member for engaging at least one of the runners when the foldable frame is in the folded position to maintain the foldable frame in the folded position.

6. The sled of claim 1, wherein the foldable frame further includes a handle, the handle having adjustable length, and wherein when the foldable frame is in the folded position the handle cooperates with at least one of the runners to maintain the foldable frame in the folded position.

7. The sled of claim 6, wherein the handle is in pressure contact with at least one of the runners when the foldable frame is in the folded position to maintain the foldable frame in the folded position.

8. A foldable chair for transporting a passenger comprising:
a pair of runners;
a frame including a pair of front legs and a pair of rear legs, each of the rear legs being pivotally joined to one of the front legs, the front legs and the rear legs being supported by the runners and at least one of the front and rear legs being pivotally joined to one of the runners, each of the front legs having an upper half and a lower half pivotally connected to the upper half, and a front crossbar joining the pair of front legs in a spaced relationship;
a seat pivotally joined to the rear legs, the seat being movable between a lowered position and a lifted position, the seat being releasably secured to the frame and supported by the front crossbar when in the lowered position for supporting the passenger and detached from the front crossbar when in the lifted position.

9. The foldable chair of claim 8, wherein the seat includes a seat base frame and a seat fabric removably attached to and supported by the seat base frame to form a seat base, the seat base frame being pivotally joined to the rear legs.

10. The foldable chair of claim 9, wherein the frame further comprises a top rail disposed between and connected to the front legs at a height above the front crossbar, and the seat has a seat back supported by the top rail and the seat base frame.

11. The foldable chair of claim 8, wherein the frame further comprises a top rail disposed between and connected to the front legs at a height above the front crossbar and the set includes a seat base frame pivotally joined to the rear legs and a seat fabric removably attached to and suspended between the seat base frame and the top rail to form the seat base and the seat back.

12. The foldable chair of claim 8, further comprising cooperating engagement arrangements formed on the seat and the frame, said cooperating engagement arrangements releasably securing the seat to the frame when the seat is in the lowered position.

13. The foldable chair of claim 12, wherein said cooperating engagement arrangements include a clamp secured to one of the seat and the frame and a mating engagement portion integrally formed on the other of the seat and the frame, said clamp releasably engaging the mating engagement portion when the seat is in the lowered position.

14. The foldable chair of claim 8, wherein the frame further includes a handle, the handle having an engagement member for engaging at least one of the runners when the frame is in a folded position to maintain the frame in the folded position.

15. The foldable chair of claim 8, wherein the frame further includes a handle, the handle being in pressure contact with at least one of the runners when the frame is in the folded position.
